(19) United States
(12) Patent Application Publication
(10) Pub. No.: US 2015/0201253 A1
(43) Pub. Date: Jul. 16, 2015

(54) METHODS AND APPARATUS FOR UNIVERSAL PRESENTATION TIMELINE ALIGNMENT

(71) Applicant: Samsung Electronics Co., Ltd., Suwon-si (KR)

(72) Inventors: Youngkwon Lim, Allen, TX (US); Imed Bouazizi, Plano, TX (US)

(21) Appl. No.: 14/592,660

(22) Filed: Jan. 8, 2015

Related U.S. Application Data
(60) Provisional application No. 61/926,001, filed on Jan. 10, 2014.

(51) Int. Cl. H04N 21/8547; H04N 21/242; H04N 21/643; H04N 21/43

(52) U.S. Cl. CPC H04N 21/8547; H04N 21/4307; H04N 21/242; H04N 21/64322

(57) ABSTRACT

A user equipment is provided for providing content. The user equipment comprising at least one memory configured to store a plurality of media content and at least one processing device. The at least one process is configured to receive a data stream over a network, the data stream comprising the plurality of media content. The at least one process is also configured to identify a mapping of a timeline for each of the plurality of media content to a universal presentation timeline. The at least one process is also configured to adjust timestamp values for each of the plurality of media content based on the universal presentation timeline.

### CROSS-REFERENCE TO RELATED APPLICATION(S) AND CLAIM OF PRIORITY

The present application claims priority to U.S. Provisional Patent Application Ser. No. 61/926,001, filed Jan. 10, 2014, entitled “METHODS AND APPARATUS FOR UNIVERSAL PRESENTATION TIMELINE ALIGNMENT”. The content of the above-identified patent document is incorporated herein by reference.

### TECHNICAL FIELD

The present application relates generally to managing presentation of media content and, more specifically, to mapping media content to a universal presentation timeline.

### BACKGROUND

Moving Picture Experts Group (MPEG) Media Transport (MMT) specifies a modern media delivery solution to enable realization of multimedia services over heterogeneous Internet Protocol (IP) network environments. The delivered coded media data includes both (i) audiovisual media data requiring synchronized decoding and presentation of specific units of data in designated times (namely timed data) and (ii) other types of data that could be decoded and presented at arbitrary times based on the context of a service or based on interaction by a user (namely non-timed data).

### SUMMARY

A user equipment is provided for providing content. The user equipment comprising at least one memory configured to store a plurality of media content and at least one processing device. The at least one process is configured to receive a data stream over a network, the data stream comprising the plurality of media content. The at least one process is also configured to identify a mapping of a timeline for each of the plurality of media content to a universal presentation timeline. The at least one process is also configured to adjust timestamp values for each of the plurality of media content based on the universal presentation timeline.

A method is provided for providing content. The method includes receiving a data stream over a network, the data stream comprising a plurality of media content. The method also includes identifying a mapping of a timeline for each of the plurality of media content to a universal presentation timeline. The method also includes adjusting timestamp values for each of the plurality of media content based on the universal presentation timeline.

A server is provided for providing content. The server includes at least one memory configured to store a plurality of media content and at least one processing device. The at least one processing device configured to identify a timeline for each of the plurality of media content. The at least one process is also configured to map each of the plurality of media content to a universal presentation timeline based on the timeline for each of the plurality of media content. The at least one process is also configured to transmit a data stream to a user equipment over a network, the data stream comprising the plurality of mapped media content

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in which various embodiments of the present disclosure may be implemented;

FIG. 2 illustrates an example device in a computing system according to this disclosure;

FIG. 3 illustrates example functionalities provided by MMT according to this disclosure;

FIG. 4 illustrates an example adaptive Hypertext Transmission Protocol (HTTP) streaming (AHS) architecture according to this disclosure;

FIG. 5 illustrates an example structure of a Media Presentation Description (MPD) file 500 according to this disclosure;

FIG. 6 illustrates an example structure of a fragmented International Standards Organization (ISO)-base file format (ISOFF) media file according to this disclosure;

FIG. 7 illustrates an example structure of a Universal Presentation Timeline (UPT) according to this disclosure; and

FIG. 8 illustrates a managing a universal presentation timeline according to this disclosure.

### DETAILED DESCRIPTION

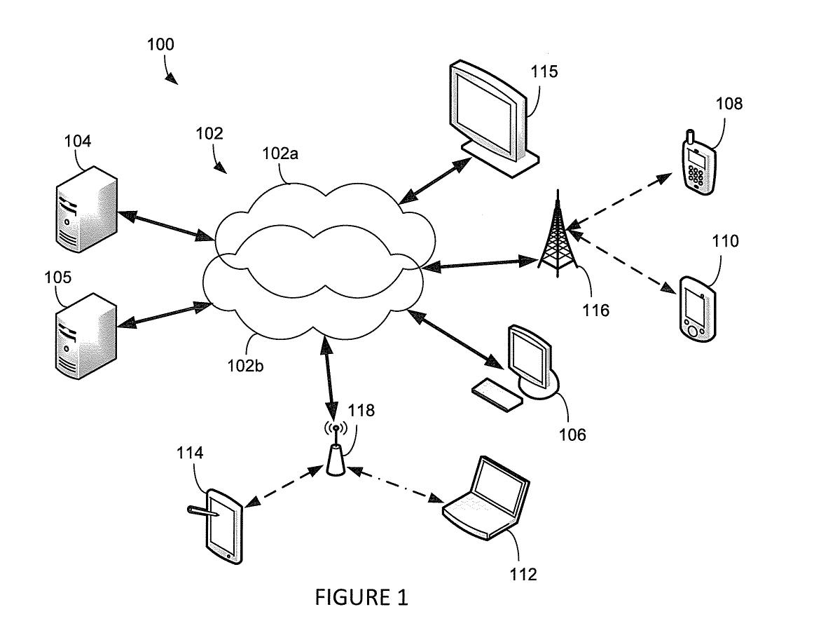

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method.

For convenience of description, the following terms and phrases used in this patent document are defined.

Content—Examples of content include audio information, video information, audio-video information, and data. Content items may include a plurality of components as described below.

Components—Refers to components of a content item, such as audio information, video information, and subtitle information. For example, a component may be a subtitle stream composed in a particular language or a video stream obtained at a certain camera angle. The component may be referred to as a track or an Elementary Stream (ES) depending on its container.

Content Resources—Refer to content items (such as various qualities, bit rates, and angles) that are provided in a plurality of representations to enable adaptive streaming for content items. A service discovery process may be referred to as content resources. The content resources may include one or more consecutive time periods.

Period—Refers to a temporal section of content resources.

Representations—Refer to versions (for all or some components) of content resources in a period. Representations may be different in a subset of components or in encoding parameters (such as bit rate) for components. Although representations are referred to here as media data, they may be referred to as any terms indicating data, including one or more components, without being limited thereto.

Segment—Refers to a temporal section of representations, which is named by a unique Uniform Resource Locator (URL) in a particular system layer type (such as Transport Stream (TS) or Moving Picture Experts Group (MPEG)-4 (MP4) Part 14).

MMT coding and media delivery is discussed in the following document and standards description: MPEG-H Systems, Text of ISO/IEC 2nd CD 23008-1 MPEG Media Transport, which is hereby incorporated into the present disclosure as if fully set forth herein. MMT defines three functional areas including encapsulation, delivery, and signaling. The encapsulation functional area defines the logical structure of media content, the MMT package, and the format data units to be processed by an MMT compliant entity. An MMT package specifies components including media content and the relationship among the media content to provide information needed for adaptive delivery. The format of the data units is defined to encapsulate the coded media to either be stored or carried as a payload of a delivery protocol and to be easily converted between storage and carrying. The delivery functional area defines the application layer protocol and format of the payload. The application layer protocol provides enhanced features, including multiplexing, for delivery of the MMT package compared to conventional application layer protocols for the delivery of multimedia. The payload format is defined to carry coded media data that is agnostic to the specific media type or encoding method. The signaling functional area defines the format of messages to manage delivery and consumption of MMT packages. Messages for consumption management are used to signal the structure of the MMT package, and messages for delivery management are used to signal the structure of payload format and configuration of the protocol.

MMT defines a new framework for delivery of time continuous multimedia, such as audio, video, and other static content, such as widgets, files, etc. MMT specifies a protocol (i.e., MMTP) for the delivery of an MMT package to a receiving entity. The MMTP signals transmission time of the MMTP package as part of the protocol header. This time enables the receiving entity to perform de-jittering by examining the transmission time and reception time of each incoming MMT packet.

For efficient and effective delivery of coded media data over heterogeneous IP network environments, MMT provides the following elements:

a logical model to construct a content composed of various components for mash-up applications;

a structure of data to convey information about the coded media data for delivery layer processing, such as packetization and adaptation;

a packetization method and a structure of packets to deliver media content agnostic to specific types of media or coding methods used over TCP or UDP, including hybrid delivery;

a format of signaling messages to manage presentation and delivery of media content; and

a format of information to be exchanged across layers to facilitate cross-layer communication.

One or more embodiments of this disclosure provide delivery and presentation of multimedia content in MMT operated based on media processing unit (MPU), which is an ISO based media file format (ISOBMFF) compliant file. The presentation time for access units (AUs) embedded in each MPU is described in the same way as in ISOBMFF. The presentation time of the first AU in each MPU is mapped to an external timeline, such as coordinated universal time (UTC), by MMT signaling messages or MMT composition information (MMT-CI).

FIG. 1 illustrates an example communication system 100 in which various embodiments of the present disclosure may be implemented. The embodiment of the communication system 100 shown in FIG. 1 is for illustration only. Other embodiments of the communication system 100 could be used without departing from the scope of this disclosure.

As shown in FIG. 1, the system 100 includes a heterogeneous network 102, which facilitates communication between various components in the system 100. For example, the network 102 may communicate Internet Protocol (IP) packets, frame relay frames, Asynchronous Transfer Mode (ATM) cells, or other information between network addresses. The network 102 may also be a heterogeneous network including broadcasting networks, such as cable and satellite communication links. The network 102 may include one or more local area networks (LANs); metropolitan area networks (MANS); wide area networks (WANs); all or a portion of a global network, such as the Internet; or any other communication system or systems at one or more locations.

In various embodiments, heterogeneous network 102 includes a broadcast network 102a and a broadband network 102b. Broadcast network 102a is designed for broadcast of media data to client devices 106-115 which is generally one way, e.g., from one or more of the servers 104-105 to the client devices 106-115. Broadcast network 102a may include any number of broadcast links and devices, such as, for example, satellite, wireless, wireline, and fiber optic network links and devices.

Broadband network 102b is designed for broadband access to media data for client devices 106-115 which is generally two way, e.g., back and forth from one or more of the servers 104-105 to the client devices 106-115. Broadband network 102b may include any number of Broadband links and devices, such as, for example, Internet, wireless, wireline, and fiber optic network links and devices.

The network 102 facilitates communications between servers 104-105 and various client devices 106-115. Each of the servers 104-105 includes any suitable computing or processing device that can provide computing services for one or more client devices. Each of the servers 104-105 could, for example, include one or more processing devices, one or more memories storing instructions and data, and one or more network interfaces facilitating communication over the network 102. For example, the servers 104-105 may include servers that broadcast media data over a broadcast network in network 102 using MMTP. In another example, the servers 104-105 may include servers that broadcast media data over a broadcast network in network 102 using DASH.

Each client device 106-115 represents any suitable computing or processing device that interacts with at least one server or other computing device(s) over the network 102. In this example, the client devices 106-115 include a desktop computer 106, a mobile telephone or smartphone 108, a personal digital assistant (PDA) 110, a laptop computer 112, a tablet computer 114; and a set-top box and/or television 115. However, any other or additional client devices could be used in the communication system 100.

In this example, some client devices 108-114 communicate indirectly with the network 102. For example, the client devices 108-110 communicate via one or more base stations 116, such as cellular base stations or eNodeBs. Also, the client devices 112-115 communicate via one or more wireless access points 118, such as IEEE 802.11 wireless access points. Note that these are for illustration only and that each client device could communicate directly with the network 102 or indirectly with the network 102 via any suitable intermediate device(s) or network(s). As described in more detail below, any and all of the client devices 106-115 may include a hybrid architecture for receiving and presenting broadcast and broadband media data using MMT and DASH.

Although FIG. 1 illustrates one example of a communication system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

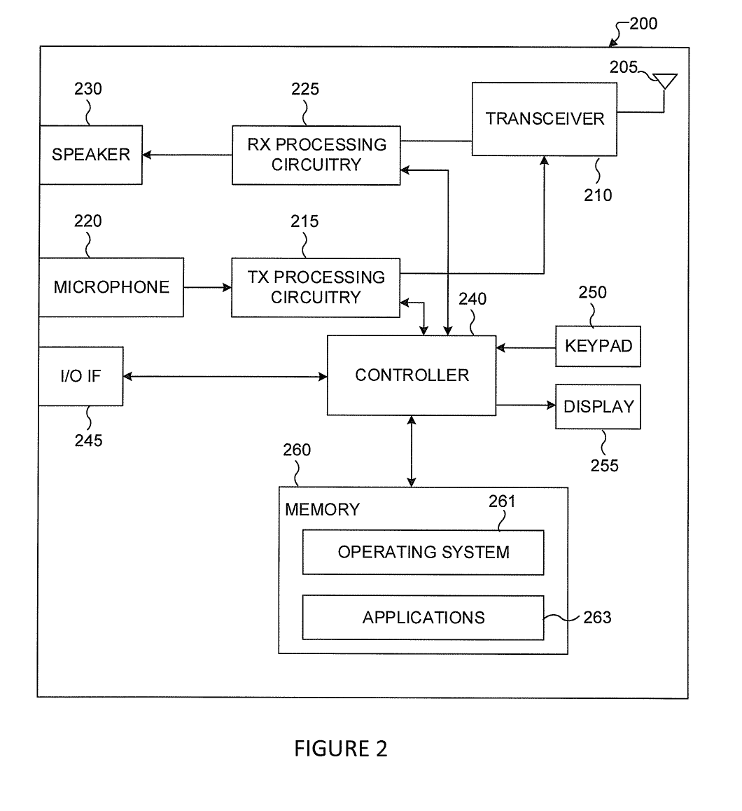

FIG. 2 illustrates an example device in a computing system according to this disclosure. In particular, FIG. 2 illustrates an example client device 200. The client device 200 could represent one or more of the client devices 106-115 in FIG. 1.

As shown in FIG. 2, the client device 200 includes an antenna 205, a transceiver 210, transmit (TX) processing circuitry 215, a microphone 220, and receive (RX) processing circuitry 225. The client device 200 also includes a speaker 220, a controller 240, an input/output (I/O) interface (IF) 245, a keypad 250, a display 255, and a memory 260. The memory 260 includes an operating system (OS) 261 and one or more applications 263.

The transceiver 210 receives, from the antenna 205, an incoming RF signal transmitted by another component in a system. The transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller 240 for further processing (such as for web browsing data).

The TX processing circuitry 215 receives analog or digital voice data from the microphone 220 or other outgoing baseband data (such as web data, e-mail, or interactive video game data) from the controller 240. The TX processing circuitry 215 encodes, multiplexes, and/or digitizes the outgoing baseband data to generate a processed baseband or IF signal. The transceiver 210 receives the outgoing processed baseband or IF signal from the TX processing circuitry 215 and up-converts the baseband or IF signal to an RF signal that is transmitted via the antenna 205.

The controller 240 can include one or more processors or other processing devices and execute the basic operating system 261 stored in the memory 260 in order to control the overall operation of the client device 200. For example, the controller 240 could control the reception of forward channel signals and the transmission of reverse channel signals by the transceiver 210, the RX processing circuitry 225, and the TX processing circuitry 215 in accordance with well-known principles. In some embodiments, the controller 240 includes at least one microprocessor or microcontroller.

The controller 240 is also capable of executing other processes and programs resident in the memory 260. The controller 240 can move data into or out of the memory 260 as required by an executing process. In some embodiments, the controller 240 is configured to execute the applications 263 based on the operating system 261 or in response to signals received from external devices or an operator. The controller 240 is also coupled to the I/O interface 245, which provides the client device 200 with the ability to connect to other devices, such as laptop computers and handheld computers. The I/O interface 245 is the communication path between these accessories and the controller 240.

The controller 240 is also coupled to the keypad 250 and the display 255. The operator of the client device 200 can use the keypad 250 to enter data into the client device 200. The display 255 may be a liquid crystal display or other display capable of rendering text and/or at least limited graphics, such as from web sites.

The memory 260 is coupled to the controller 240. Part of the memory 260 could include a random access memory (RAM), and another part of the memory 260 could include a Flash memory or other read-only memory (ROM).

As described in more detail below, client device 200 may include a hybrid architecture for receiving and presenting broadcast and broadband media data using MMT and DASH.

Although FIG. 2 illustrates an example of a device in a computing system, various changes may be made to FIG. 2. For example, various components in FIG. 2 could be combined, further subdivided, or omitted, and additional components could be added according to particular needs. As a particular example, the controller 240 could be divided into multiple processors, such as one or more central processing units (CPUs) and one or more graphics processing units (GPUs). Also, while FIG. 2 illustrates the client device 200 configured as a mobile telephone or smartphone, client devices could be configured to operate as other types of mobile or stationary devices including, for example, without limitation, a set-top box, a television, and a media streaming device. In addition, as with computing and communication networks, client devices and servers can come in a wide variety of configurations, and FIG. 2 does not limit this disclosure to any particular client device or server.

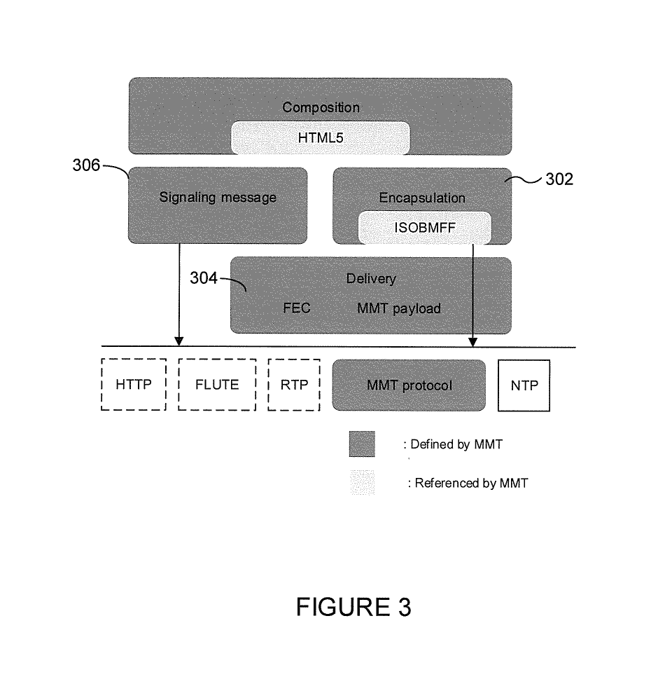

FIG. 3 illustrates example functionalities provided by MMT according to this disclosure. The embodiment shown in FIG. 3 is for illustration only. Other embodiments could be used without departing from the scope of this disclosure.

Functionalities provided by MMT are categorized into functional areas, namely a composition area, an encapsulation area 302, a delivery area 304, and a signaling area 306. The encapsulation area 302 defines the logical structure of media content, an MMT package, and a format of the data units to be processed by an MMT-compliant entity. An MMT package includes one or more components having media content and descriptions of relationships among the components to provide information to the underlying delivery area 304 for adaptive operation. The format of the data units is defined to encapsulate the coded media data of the media content to be stored or carried as a payload of a delivery protocol and to be easily converted between different delivery protocols.

The delivery area 304 defines a transport protocol (MMTP) and a payload format. MMTP provides enhanced features for delivery of media data compared to conventional file delivery protocols such as FLUTE. The payload format is defined to carry ISO-media base file format encapsulated coded media data in a way agnostic to the specific media type or encoding method.

The signaling area 306 defines the format of messages to manage delivery and consumption of MMT packages. Messages for consumption management are used to signal the structure of MMT Package and messages for delivery management are used signal the structure of payload format and configuration of the protocol.

The encapsulation area 302 defines a logical structure of the media content, the MMT Package, and the format of the data units to be processed by the MMT compliant entity. The MMT Package specifies the components comprising media content and the relationship among them to provide necessary information for presentation and adaptive delivery. The format of the data units is defined to encapsulate the coded media either to be stored or to be carried as a payload of a delivery protocol, and to be easily converted between the different formats.

Any type of data that can be individually consumed by an entity directly connected to an MMT client is a separate MMT asset. This includes not only coded media data decodable by a single media codec but also other types of data that have already been multiplexed. MPUs provide information about the media data for adaptive packetization according to the constraints of the underlying delivery area's packet size, such as the boundaries and sizes of small fragments of the data carried in the MPU. Such small fragments are known as Media Fragment Units (MFUs). This enables the underlying delivery area entity to dynamically packetize the MPUs adaptively based on the size of the maximum transmission unit of the delivery area 304. MFUs carry small fragments of coded media data for which such fragments can be independently decoded or discarded, such as a Network Abstraction Layer (NAL) Unit of an Advanced Video Coding (AVC) bitstream.

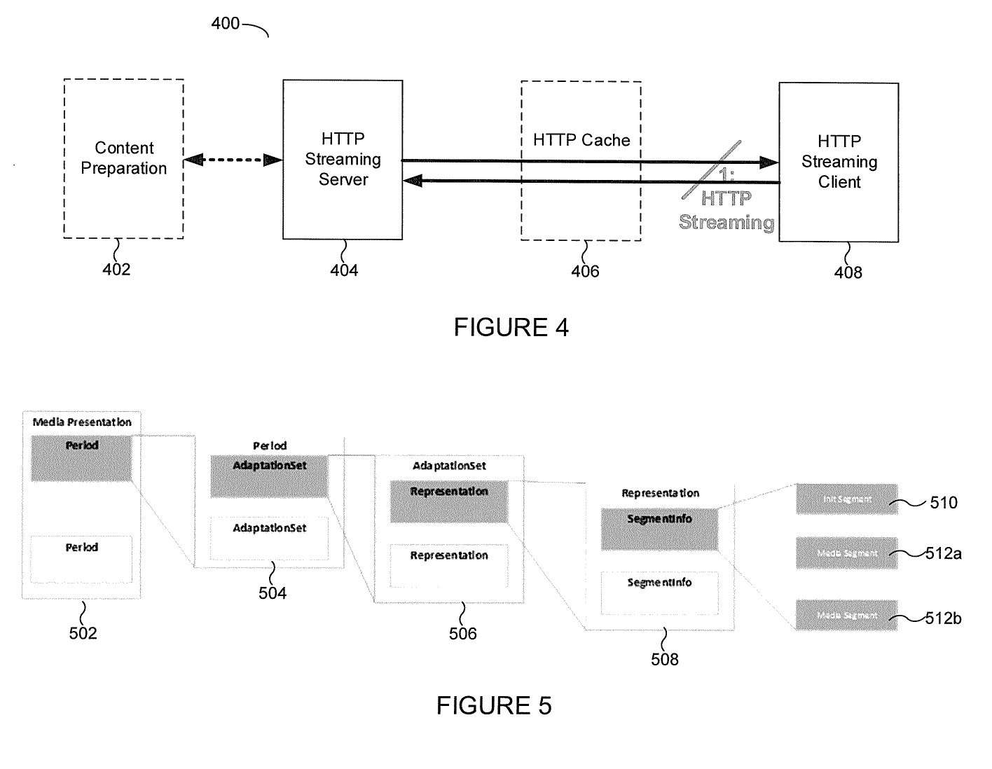

FIG. 4 illustrates an example adaptive Hypertext Transmission Protocol (HTTP) streaming (AHS) architecture 400 according to this disclosure. As shown in FIG. 4, the architecture 400 includes a content preparation module 402, an HTTP streaming server 404, an HTTP cache 406, and an HTTP streaming client 408. In some embodiments, the architecture 400 may be implemented in the system 100.

FIG. 5 illustrates an example structure of a Media Presentation Description (MPD) file 500 according to this disclosure. As shown in FIG. 5, the MPD file 500 includes a media presentation 502, a period 504, an adaption set 506, a representation 508, an initial segment 510, and media segments 512a-512b. In some embodiments, the MPD file 500 may be implemented in the client device 200 as shown in FIG. 2.

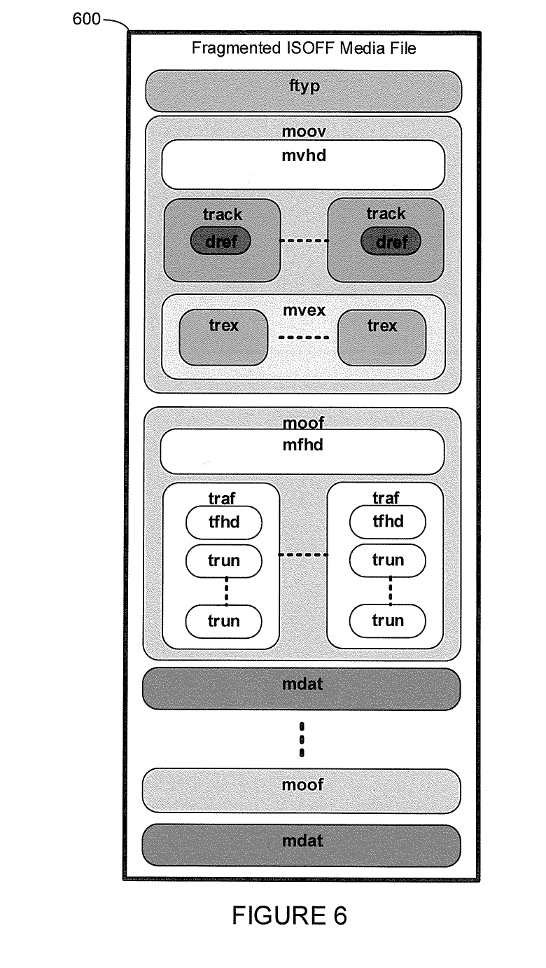

FIG. 6 illustrates an example structure of a fragmented International Standards Organization (ISO)-base file format (ISOFF) media file 600 according to this disclosure. In some embodiments, the ISOFF media file 600 may be implemented in the system 100. In one deployment scenario of DASH, the ISO-base file format and its derivatives (such as the MP4 and 3GP file formats) are used. The content is stored in so-called movie fragments. Each movie fragment contains media data and the corresponding metadata. The media data is a collection of media samples from all media components of the representation. Each media component is described as a track of the file.

One or more embodiments of this disclosure recognize and take into account that MMT-CI provides tools for describing the association of multiple contents, which might be delivered independently, into a single presentation or service.

One or more embodiments of this disclosure recognize and take into account that as MMT-CI describes the presentation time of the first AU of each MPU, it can describe splicing at the boundary of MPUs. MMT-CI also includes technologies to partially update it without entirely reloading new version of it. MMT may not provide any information about prefetching as it basically assumes push delivery of content. HRBM can absorb the difference of delays of multiple delivery networks in hybrid delivery scenarios.

One or more embodiments of this disclosure recognize and take into account that hybrid delivery applications can involve mash-up applications that combine multiple individually-created and serviced content into a single presentation or content. As a result, the original multimedia data and its timeline could be agnostic to such combinations and timeline alignments. It would be very inefficient and inconvenient if each content needed to be modified at each service. Therefore, one or more embodiments of this disclosure define a new timeline independent of each media timeline embedded in the content and maps the presentation time of each content to such new timeline.

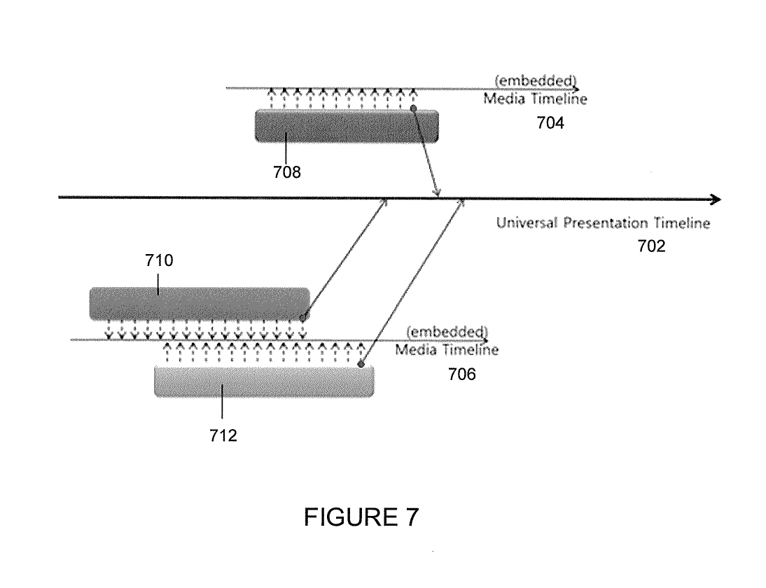

FIG. 7 illustrates an example structure of a Universal Presentation Timeline (UPT) 702 according to this disclosure. As shown in FIG. 7, the universal presentation timeline 702 includes references to media files on media timelines 704 and 706. In some embodiments, the universal presentation timeline 702 may be implemented in the client device 200 as shown in FIG. 2.

In FIG. 7, there is media content 708, 710, and 712 that each embed an internal media timeline, such as media timelines 704 and 706. A new timeline, UPT 702, is independently defined. Some presentation times of the media content 708, 710, and 712 are mapped to the UPT 702 for timeline alignment. The media content 708, 710, and 712 is then presented according to the presentation times on the UPT 702.

The UPT can be locked to, for example, UTC or other known time or to one of the media timelines (such as a PCR-based timeline of an MPEG-2 TS) depending on the application. Signaling information for defining the UPT and mapping the presentation times to the UPT could be provided in any suitable manner, such as in a separate file. This approach could be used with any number of media contents.

Timeline 706 can include media content 710 and 712. Media content 710 and 712 can be audio or video content. For example, media content 710 can be video content while media content 712 can be audio content.

In this example, media content 708, 710, and 712 can be mapped to locations on the UPT 702.

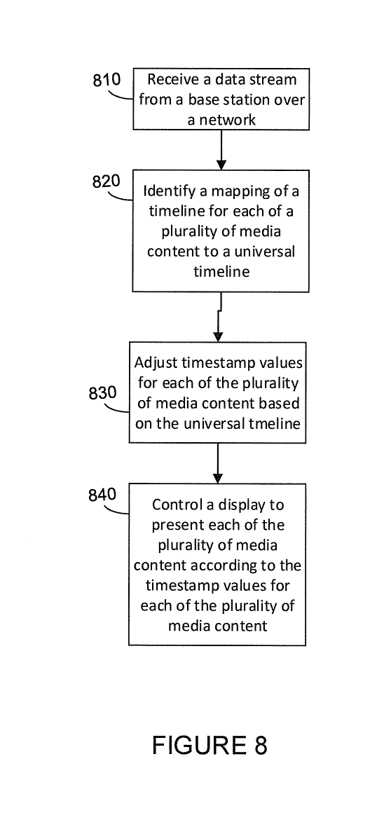

FIG. 8 illustrates a managing a universal presentation timeline according to this disclosure. In an example, the client device 200 in FIG. 2 may implement the process.

In accordance with an embodiment of this disclosure, at operation 810, the client device receives a data stream over a network. The data stream can be sent via Wi-FI, through the Internet, from a base station, from another mobile device, over the cellular network, and the like. The data stream includes a plurality of media content.

At operation 820, the client device identifies a mapping of a timeline for each of the plurality of media content to a universal presentation timeline. In an example embodiment, when identifying the mapping, the client device may receive the mapping of the timeline for each of the plurality of media content to the universal presentation timeline separately from the data stream comprising the plurality of media content.

At operation 830, the client device adjusts timestamp values for each of the plurality of media content based on the universal presentation timeline. At operation 840, the client device controls a display to present each of the plurality of media content according to the timestamp values for each of the plurality of media content.

In an example embodiment, the timeline for each of the plurality of media content is based on an internal processor clock. In an example embodiment, the universal presentation timeline is based on coordinated universal time. In an example embodiment, a server maps the timeline for each of the plurality of media content to the universal presentation timeline. In an example embodiment, the universal presentation timeline is based on an event.

It can be advantageous to set forth definitions of certain words and phrases used throughout this patent document. The teem “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described in this patent document can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user equipment for providing content, the user equipment comprising:
at least one memory configured to store a plurality of media content; and
at least one processing device configured to:
receive a data stream over a network, the data stream comprising the plurality of media content;
identify a mapping of a timeline for each of the plurality of media content to a universal presentation timeline;
adjust timestamp values for each of the plurality of media content based on the universal presentation timeline.

2. The user equipment of claim 1, wherein the at least one processing device is further configured to:
control a display to present each of the plurality of media content according to the timestamp values for each of the plurality of media content.

3. The user equipment of claim 1, wherein the timeline for each of the plurality of media content is based on an internal processor clock.

4. The user equipment of claim 1, wherein the universal presentation timeline is based on coordinated universal time.

5. The user equipment of claim 1, wherein a server maps the timeline for each of the plurality of media content to the universal presentation timeline.

6. The user equipment of claim 1, wherein the universal presentation timeline is based on an event.

7. The user equipment of claim 1, wherein identify the mapping of the timeline for each of the plurality of media content to the universal presentation timeline comprises the at least one processing device configured to:
receive the mapping of the timeline for each of the plurality of media content to the universal presentation timeline separately from the data stream comprising the plurality of media content.

8. A method for providing content, the method comprising:
receiving a data stream from a base station over a network, the data stream comprising a plurality of media content;
identifying a mapping of a timeline for each of the plurality of media content to a universal presentation timeline;
adjusting timestamp values for each of the plurality of media content based on the universal presentation timeline.

9. The method of claim 8, further comprising:
controlling a display to present each of the plurality of media content according to the timestamp values for each of the plurality of media content.

10. The method of claim 8, wherein the timeline for each of the plurality of media content is based on an internal processor clock.

11. The method of claim 8, wherein the universal presentation timeline is based on coordinated universal time.

12. The method of claim 8, wherein a server maps the timeline for each of the plurality of media content to the universal presentation timeline.

13. The method of claim 8, wherein the universal presentation timeline is based on an event.

14. The method of claim 8, wherein identify the mapping of the timeline for each of the plurality of media content to the universal presentation timeline comprises:
receiving the mapping of the timeline for each of the plurality of media content to the universal presentation timeline separately from the data stream comprising the plurality of media content.

15. A server, comprising:
at least one memory configured to store a plurality of media content; and
at least one processing device configured to:
identify a timeline for each of the plurality of media content;
map each of the plurality of media content to a universal presentation timeline based on the timeline for each of the plurality of media content;
transmit a data stream to a user equipment over a network, the data stream comprising the plurality of mapped media content.

16. The server of claim 15, wherein the timeline for each of the plurality of media content is based on an internal processor clock.

17. The server of claim 15, wherein the universal presentation timeline is based on coordinated universal time.

18. The server of claim 15, wherein a user equipment adjusts timestamp values for each of the plurality of media content based on the universal presentation timeline.

19. The server of claim 15, wherein the universal presentation timeline is based on an event.

20. The server of claim 15, wherein transmit the data stream to the user equipment over the network further comprises:
transmitting the mapping of the timeline for each of the plurality of media content to the universal presentation timeline separately from the data stream comprising the plurality of media content.
